(19) United States
(12) Patent Application Publication
(10) Pub. No.: US 2019/0279041 A1
(43) Pub. Date: Sep. 12, 2019

(54) INFORMATION PROCESSING APPARATUS

(71) Applicant: FUJI XEROX CO., LTD., Tokyo (JP)

(72) Inventors: Shunichi KIMURA, Kanagawa (JP); Ikken SO, Kanagawa (JP); Takuya SAKURAI, Kanagawa (JP); Kumi FUJIWARA, Kanagawa (JP); Yutaka KOSHI, Kanagawa (JP)

(73) Assignee: FUJI XEROX CO., LTD., Tokyo (JP)

(21) Appl. No.: 16/100,556

(22) Filed: Aug. 10, 2018

(30) Foreign Application Priority Data
Mar. 7, 2018 (JP) 2018-040657
Mar. 20, 2018 (JP) 2018-053024

(51) Int. Cl. G06K 9/62; G09B 7/02; G06F 17/18

(52) U.S. Cl. CPC G06K 9/6263; G06F 17/18; G06K 9/6256; G09B 7/02

(57) ABSTRACT

An information processing apparatus includes: an acquisition unit that acquires, for each past input for a determining unit, a group of sets each including a determination accuracy on an input and correct/incorrect answer information indicating whether a determination result from the determining unit on the input is a correct or incorrect answer; and a determination unit that determines each threshold for defining each section by using the group acquired by the acquisition unit in an order starting from a section where the determination accuracy is relatively high and in such a manner that a correct answer rate of the determining unit obtained from the group of sets that belongs a section satisfies a target correct answer rate of the determining unit corresponding to the section.

### CROSS-REFERENCE TO RELATED APPLICATIONS

This application is based on and claims priority under 35 USC 119 from Japanese Patent Application No. 2018-040657 filed Mar. 7, 2018 and Japanese Patent Application No. 2018-053024 filed Mar. 20, 2018.

### BACKGROUND

### (i) Technical Field

The present disclosure relates to an information processing apparatus.

### (ii) Related Art

JP-A-2003-346080 discloses a method which performs a character recognition for an image on an input form; obtains a similarity as the character recognition result; compares the obtained similarity with a previously registered certainty which is required for the character recognition; and performs an output that does not require a manual verification process for the character recognition result based on the comparison result, performs an output that urges the manual verification process for the character recognition result by presenting options of character-recognized candidates based on the comparison result, or performs an output that urges a manual input process for the character recognition result by presenting a manual new input and checking based on the comparison result.

JP-A-2003-296661 discloses a character recognition device including: a character recognition unit that recognizes a coordinate point sequence of a character input by a handwriting so as to output a recognition candidate character group; a feature extraction unit that calculates an average writing speed of the coordinate point sequence of the character input by the handwriting as a feature amount for calculating a reliability of the determination target recognition candidate character group output from the character recognition unit; a reliability calculation unit that calculates the reliability of the determination target recognition candidate character group based on the feature amount from the feature extraction unit and a statistical tendency of sample data; and a post-processing controller that controls a post-processing of the determination target recognition candidate character group based on the reliability from the reliability calculating unit.

JP-A-2000-259847 discloses a method which extracts a logical element from an input document image, identifies whether the extracted logical element is a character string region, recognizes characters of the identified character string region, and displays the recognition result in a text when the certainty of the recognition result is equal to or more than a threshold, and displays the recognition result in a partial image when the certainty is less than the threshold.

JP-A-2016-212812 discloses an information processing apparatus in which a classification unit classifies a character recognition target to belong to any one of three types; an extraction unit extracts a character recognition result for the character recognition target when the character recognition target is classified to belong to a first type by the classification unit; a first controller extracts the character recognition result for the character recognition target and performs a control to cause the character recognition target to be manually input when the character recognition target is classified to belong to a second type by the classification unit; and a second controller performs a control to cause the character recognition target to be manually input by multiple persons when the character recognition target is classified to belong to a third type by the classification unit.

JP-A-2004-171326 discloses a method in which when old-version character recognition software is changed into new-version character recognition software, an actual system performs the character recognition with both the pieces of new- and old-version software for a time period when the old-version software is transitioned to the new-version software. As a result, information on the recognition accuracy of both the pieces of new- and old-version software is statistically collected, and the recognition accuracy of both is compared. Then, when the accuracy of the new version is higher than the accuracy of the old version, the introduction of the new-version software is determined. Meanwhile, when the recognition accuracy of the old-version software is relatively high, the old-version software is not entirely changed to the new-version software, and both the pieces of old- and new-version software may be operated in parallel by using the advantages of both the pieces of software.

In the method disclosed in JP-A-05-274467, character information is read from an input document through OCR, and recognized in a recognition processor. A verification input is performed in the manner that the character information on the input document is caused to be key-input by an operator from a keyboard, the CPU compares the key-input character data and the recognition data of the character recognition with each other, and a part of the key-input data which is likely to be erroneous is displayed to be abnormal with CRT 15. For example, the character data is displayed to be abnormal in a reversal manner (white) when it is determined that the key-input character data matches the input document, and the recognition data is erroneous, or when it is determined that not only the recognition data but also the key-input character data are erroneous. In this way, input data which is highly likely to be erroneously input may be automatically detected.

JP-A-2010-073201 discloses a device including: an image reading unit that reads a form with data entered therein as an electronic image form; an OCR recognition unit that performs an OCR recognition of the read electronic image form by two (or more) types of OCR engines having different properties, that is, OCR engines that do not or hardly perform a false recognition in common; and a database storage unit that automatically stores a character in a database when the recognition results of the character match each other, and checks, corrects, and then, stores a character in the database when the recognition results of the character match each other but the reliability of the recognition by any one of the OCR engines is relatively low.

JP-A-05-040853, JP-A-05-020500, JP-A-05-290169, JP-A-08-101880, JP-A-09-134410, and JP-A-09-259226 disclose various methods for calculating the recognition accuracy of the character recognition.

In a system where an input is determined, and the determination result is processed at a post-stage processing corresponding to a section that belongs to the determination accuracy of the determination result, among multiple post-stage processings, it is necessary to set thresholds for dividing the sections. The thresholds are required to reflect the information of determination results accumulated in the past. However, any related art has not suggested a device or method for determining the thresholds.

In a case of determining an input by a determining unit, in order to obtain a correct answer rate of the determination by the determining unit, there is, for example, a method which determines whether the determination result by the determining unit for each input is a correct answer, by a method providing a relatively high determination accuracy (e.g., check by a human being), so as to obtain the ratio of the result of determination of the correct answer to the entire input. However, the method with the relatively high determination accuracy is more expensive than the determination by the determining unit. This is because otherwise, the method of the high determination accuracy may be used from the first instead of the determining unit. Thus, when the determination by the method is performed for the entire input, the burden of costs is large.

### SUMMARY

Aspects of non-limiting embodiments of the present disclosure relate to providing an apparatus for determining thresholds that reflect information on past accumulated determination results.

Aspects of non-limiting embodiments of the present disclosure also relate to obtaining a correct answer rate of a determining unit at a lower cost than a method of obtaining the correct answer rate of the determining unit by using a separate method to determine a correct/incorrect answer of a determination result from the determining unit for all inputs.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus useful for a determining system including: a determining unit that determines an input; a calculation unit that calculates a determination accuracy of the determining unit on the input; plural post-stage processing units that are each capable of generating an output for the input by performing a post-stage processing on a determination result from the determining unit, have different degrees of dependency on the determination result from the determining unit in generating the output, and are associated with sections, respectively, obtained by dividing, by one or more thresholds, a range where the determination accuracy can lie; and a control unit that performs a control to cause, to generate the output for the input, one of the plural post-stage processing units that corresponds to a section to which the determination accuracy calculated by the calculation unit belongs, the information processing apparatus being configured to determine the thresholds for the division into the sections for the determination accuracy and including: an acquisition unit that acquires, for each past input for the determining unit, a group of sets each including the determination accuracy on the input and correct/incorrect answer information indicating whether the determination result from the determining unit on the input is a correct or incorrect answer; and a determination unit that determines each of the thresholds for defining each section by using the group acquired by the acquisition unit in an order starting from a section where the determination accuracy is relatively high and in such a manner that a correct answer rate of the determining unit obtained from the group of sets that belongs a section satisfies a target correct answer rate of the determining unit corresponding to the section.

### BRIEF DESCRIPTION OF THE DRAWINGS

Exemplary embodiments of the present disclosure will be described in detail based on the following figures, wherein:

FIG. 1 is a view illustrating an example of a determining system to which a threshold setting processing device according to an exemplary embodiment is applied;

FIG. 2 is a view for explaining learning data which is input to the threshold setting processing device;

FIG. 3 is a view illustrating a functional configuration of the threshold setting processing device;

FIG. 4 is a view illustrating a procedure of a threshold calculation unit;

FIG. 5 is a view for explaining a processing performed by the threshold calculation unit;

FIG. 6 is a view for explaining a progressing method of the processing by the threshold calculation unit;

FIG. 7 is a view illustrating a detailed procedure of a threshold determination processing in the threshold calculation unit;

FIG. 8 is a view illustrating main components of a specific example of the determination;

FIG. 9 is a view illustrating a functional configuration of an information processing apparatus according to another exemplary embodiment;

FIG. 10 is a view for explaining an example of a method of estimating a correct answer rate in a region where a recognition accuracy is equal to or more than a threshold;

FIG. 11 is a view for explaining a method of calculating a probability density function of the recognition accuracy;

FIG. 12 is a view for explaining another example of the method of estimating the correct answer rate in the region where the recognition accuracy is equal to or more than a threshold;

FIG. 13 is a view for explaining another example of the method of estimating the correct answer rate in the region where the recognition accuracy is equal to or more than a threshold; and

FIG. 14 is a view illustrating an internal configuration of a verification processing unit.

### DETAILED DESCRIPTION

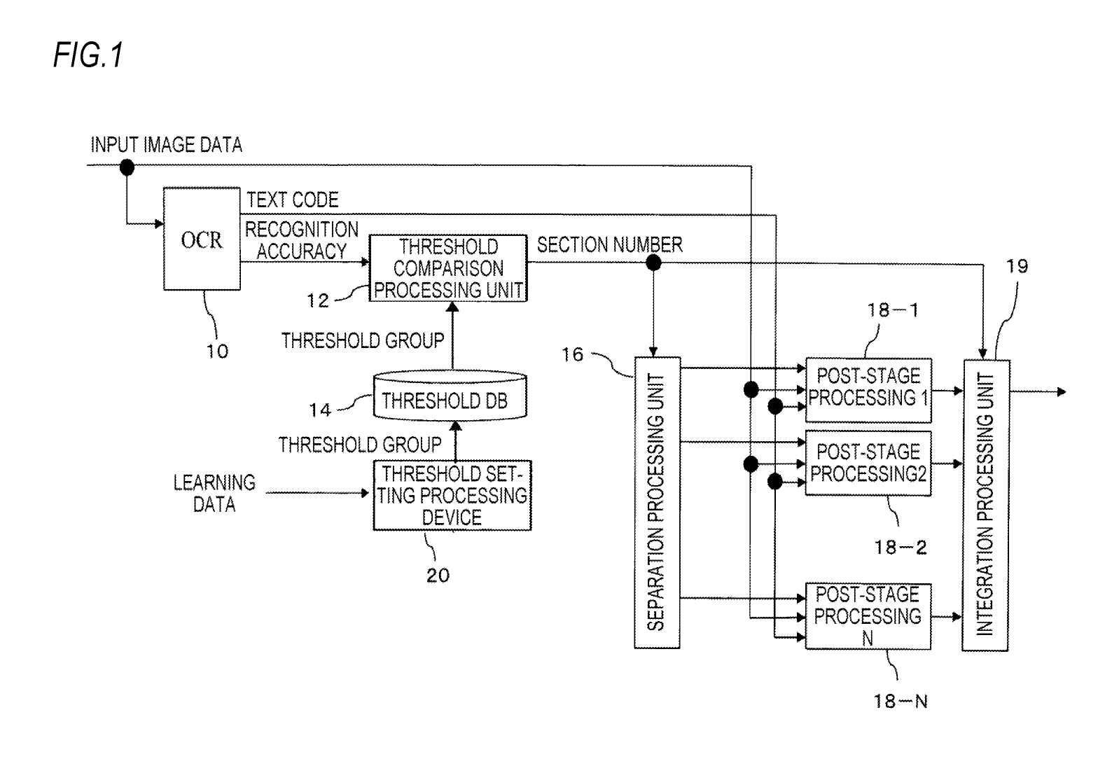

FIG. 1 illustrates an example of a threshold setting processing device 20 which is an exemplary embodiment of an information processing apparatus according to the present disclosure, and a determining system using the threshold setting processing device 20.

In this determining system, a character string included in input image data is determined by an OCR 10 and N post-stage processing units 18-1, 18-2, . . . , and 18-N (N is an integer equal to or more than 2; hereinafter, collectively referred to as a post-stage processing unit 18 when the post-stage processing units need not to be discriminated from each other).

The OCR 10 recognizes the character string included in the input image data by performing a well-known OCR (optical character recognition) processing on the input image data. The OCR 10 outputs a text code indicating the character string recognized from the input image data and a recognition accuracy, as a set. The recognition accuracy refers to a degree of an accuracy indicating that the text code of the recognition result accurately represents the character string (which may be a handwriting) included in the input image data. As the recognition accuracy is high, the text code of the recognition result is highly likely to be correct (that is, the text code accurately represents the character string in the input image data). Hereinafter, the possibility that the recognition result is a correct answer will be called a recognition rate or correct answer rate. The OCR 10 may output multiple different recognition results on the input image data in association with recognition accuracies in a descending order of the recognition accuracy. In addition, the unit in which the OCR 10 performs the character recognition (i.e., the unit in which the recognition result is output) is not specifically limited, and may be, for example, any of a character unit, a line or column unit (horizontal or vertical writing), a page unit, and a document unit.

In addition, a character recognition method or a recognition accuracy calculation method which is used by the OCR 10 is not specifically limited, and any one of methods of related art including the methods disclosed in JP-A-2004-171326, JP-A-05-274467, JP-A-2010-073201, JP-A-05-040853, JP-A-05-020500, and JP-A-05-290169 and methods to be developed in the future may be used.

In principle, each of the N post-stage processing units 18 receives the text code of the recognition result by the OCR 10, and determines its final character recognition result by using the received text code and recognition results of the character string in the input image data by 0 or more other units. For example, one recognition result is selected from the result of recognition by the OCR 10 and the result of recognition by the “other units” according to a specific (i.e., predetermined) rule, and output as the final character recognition result. The units to be used as the “other units” (there may be a case where the other units are not used) and the rule for selecting the recognition result to be output are determined for each post-stage processing unit 18. The “other units” used by the post-stage processing unit 18 for the character recognition are, for example, a person and a character recognition service outside the present system. As for the external character recognition service, for example, a character recognition service is used which is expected to provide a higher average recognition rate (correct answer rate) than the OCR 10, but costs for use (when the cost for using the OCR 10 may be regarded as zero) or requires a higher use cost than that for the OCR 10. In addition, the N post-stage processing units 18 may include one which does not use the result of

The N post-stage processing units 18 are defined with rankings in an order of 1, 2, 3, . . . , and N, and as the numeral of the order is large, the dependency on the OCR 10 is high. More strictly, as the numeral of the order is large, the dependency on the OCR 10 monotonically increases. In addition, as the post-stage processing unit 18 has the large numeral of the order, the cost required for the processing of the corresponding post-stage processing unit 18 (the cost finally converted into an amount) is low. More strictly, as the numeral of the order becomes larger, the processing cost monotonously decreases.

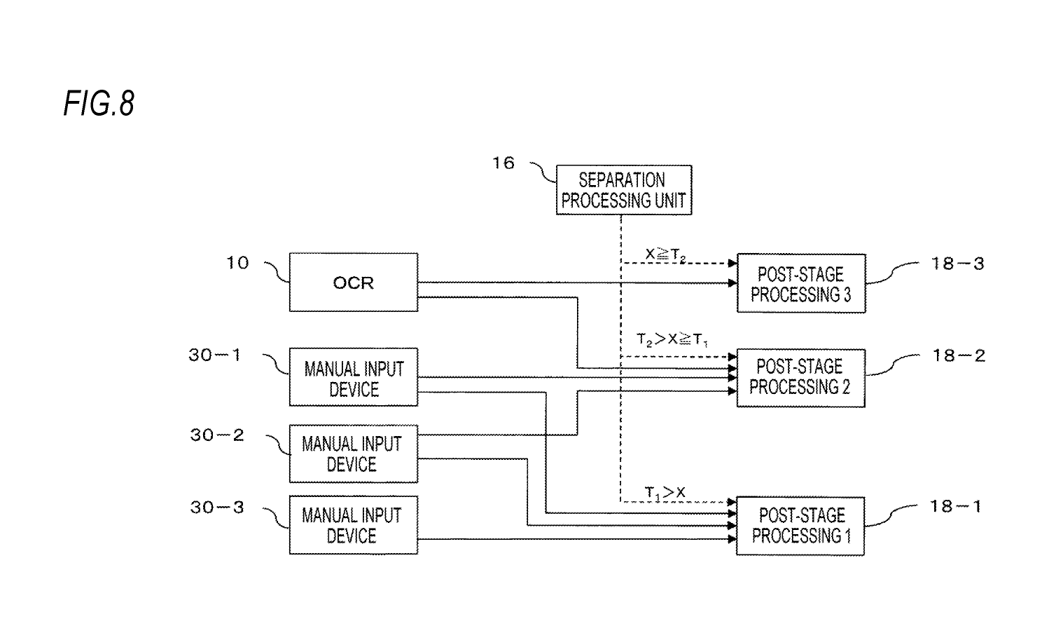

For example, the post-stage processing unit 18-N which is the last in order (hereinafter, the post-stage processing unit 18-K is also referred to as the “post-stage processing K” for simplification, in which K is an integer from 1 to N) may be a post-stage processing unit that directly outputs the text code of the character recognition result from the OCR 10 as the final character recognition result, as in “post-stage processing 3” of FIG. 8 described later. In this example, since the post-stage processing N uses only the result of recognition by the OCR 10 for determining the final character recognition result without using “other units,” the dependency on the OCR 10 is, so to speak, 100%. In addition, in this example, since the post-stage processing N does not use units other than the OCR 10 which perform the character recognition, an additional cost for the character recognition by the units other than the OCR 10 is 0.

In addition, the post-stage processing unit 18-1 which is the first in order (“post-stage processing 1”) may determine the final recognition result only from the character recognition results of one or more “other units” without using the result of recognition by the OCR 10. In this example, the dependency of the post-stage processing N on the OCR 10 is, so to speak, 0%. The post-stage processing N may be a post-stage processing in which when character strings input by two persons who see and recognize input image data match each other, the matching character string is determined to be the final recognition result, and when both do not match each other, a character recognition result by another person is determined to be the final recognition result, like a “post-stage processing 1” of FIG. 8 to be described later. In this case, since at least two up to three persons are necessary, the required processing cost is high.

In addition, for example, like a “post-stage processing 2” illustrated in FIG. 8 to be described later, a post-stage processing unit 18 may be used in which when the result of recognition by the OCR 10 matches a character string of a recognition result input by a first person who sees the same input image data, the recognition result is adopted as the final recognition result, and when both do not match each other, a recognition result input by a second person who sees the same input image data is adopted as the final recognition result (referred to as a post-stage processing A). The dependency of the post-stage processing A on the OCR 10 and the required processing cost are between those of the post-stage processing N that adopts the result of recognition by the OCR 10 as it is as the final recognition result as described above, and those of the post-stage processing unit 1 that does not use the OCR 10 at all.

In addition, as one of the post-stage processing units 18, for example, a post-stage processing unit may be used which uses an external relatively high-level (and high-cost) character recognition system (referred to as a post-stage processing B), instead of the first person in the post-stage processing A described above. When the result of recognition by the OCR 10 and the result of recognition by the external character recognition system match with each other, the post-stage processing unit 18 adopts the recognition result as the final recognition result, and when both do not match each other, the post-stage processing unit 18 adopts the recognition result input by a person who sees the same input image data, as the final recognition result. Since the post-stage processing B uses the result of recognition by the OCR 10 in the same manner as used in the post-stage processing A, the dependency of the post-stage processing B on the OCR 10 may be regarded as being equal to that of the post-stage processing A. Since a person generally costs higher than a character recognition system by a computer, the cost of the post-stage processing B is lower than that of the post-stage processing A. Thus, the order of the post-stage processing B follows the order of the post-stage processing A (the numeral is large).

In addition, for example, a post-stage processing unit 18 may be used in which when the input image data and the result of recognition by the OCR 10 are presented to a person, and the person determines that the result of recognition by the OCR 10 is accurate, a simple input to that effect is received (e.g., a correct answer button is pressed), and when the person determines that the result of recognition by the OCR 10 is incorrect, an input of a character string of the result of recognition by the person is received as the final recognition result (referred to as a “post-stage processing C”). The post-stage processing C costs higher than the example of the post-stage processing N that does not use “other means” at all as described above, but costs lower than the post-stage processing A or B described above (because the post-stage processing C uses one person as “other means”). Further, considering that other than the OCR 10, fewer units are involved in the determination of the final recognition result than those in the post-stage processing A or B, it may be said that the dependency on the OCR 10 is higher than that of the post-stage processing A or B. Thus, the order of the post-stage processing C is between the example of the post-stage processing N that does not use “other means” at all and the post-stage processing A.

In addition, as a variation of the post-stage processing C, a post-stage processing D may be used in which some of the multiple recognition result candidates recognized by the OCR 10 from the same input image data are presented to a person in a descending order of the recognition accuracy, such that when the candidates include a correct answer, the person performs a simple operation to select the correct answer, and when the candidates include no correct answer, a character string recognized by the person is input. In the post-stage processing D, since the labor of input by a person is reduced, the number of processings per hour increases as much. Accordingly, the cost per hour is expected to be lower than that in the post-stage processing C. Thus, the order of the post-stage processing D follows the order of the post-stage processing C.

In the present exemplary embodiment, the recognition accuracy obtained by the OCR 10 is divided into N sections, and the N post-stage processing units 18 are associated with the N sections one by one in ranking order. That is, a relatively high ranking post-stage processing unit 18 is associated with a section of a relatively high recognition accuracy. Then, in order to verify the final character recognition result on the input image data, the determining system selects and operates the post-stage processing unit 18 associated with a section to which the recognition accuracy output by the OCR 10 on the input image data belongs, among the N ranked post-stage processing units 18. The unselected post-stage processing units 18 are not operated.

A threshold DB 14 illustrated in FIG. 1 holds N−1 thresholds for the division into the N sections. A threshold comparison processing unit 12 compares the recognition accuracy obtained by the OCR 10 on the text code of the recognition result to be output with the N−1 thresholds, so as to determine to which of the N sections the recognition result belongs. This determination result is any one number from 1 to N which indicates the section, and the number functions as information for specifying the post-stage processing unit 18 corresponding to the section. A separation processing unit 16 receives the section number output by the threshold comparison processing unit 12, and selectively activates the post-stage processing unit 18 corresponding to the section number, among the N post-stage processing units 18. The activated post-stage processing unit 18 determines and outputs the final character recognition result on the input image data by using input information (e.g., the result of recognition by the OCR 10 and the input image data). The other post-stage processing units 18 do not operate. An integration processing unit 19 outputs the output of the post-stage processing unit 18 corresponding to the section number obtained from the threshold comparison processing unit 12, among the N post-stage processing units 18, as the result of character recognition by the determining system on the input image data. The integration processing unit 19 discards the outputs of the other post-stage processing units 18 (even when the outputs exist).

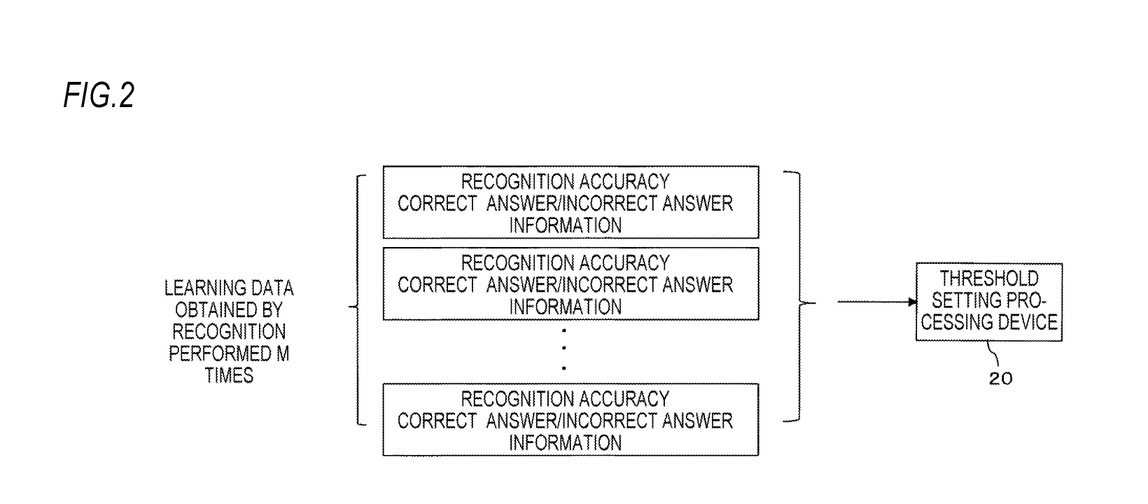

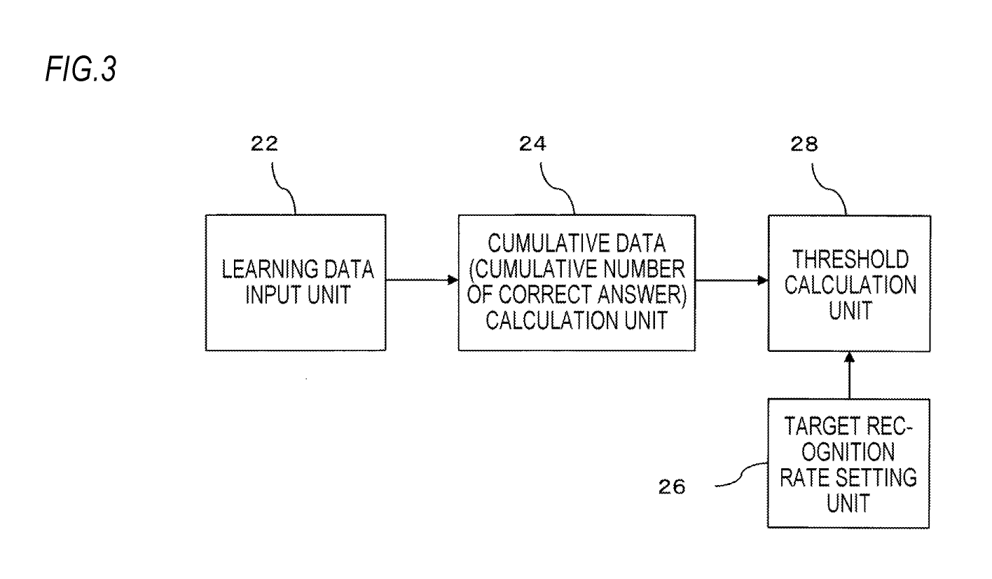

The threshold value group held in the threshold DB 14 is set by the threshold setting processing device 20. The threshold setting processing device 20 determines the N−1 thresholds by processing a large number of learning data. As for the learning data, as illustrated in FIG. 2, a value of a recognition accuracy of each of character recognitions performed by the OCR 10 M times (a great number of times) in the past, and correct answer/incorrect answer information indicating whether the result of the character recognition is correct or incorrect are used as a set. As for the value of the recognition accuracy, a value output by the OCR 10 may be recorded. In addition, the correct answer/incorrect answer information is a binary value indicating whether the result of the character recognition is a correct answer or incorrect answer. In the following descriptions, the correct answer/incorrect answer information indicates “1” when the result of the character recognition is a correct answer, and indicates “0” when the result of the character recognition is an incorrect answer. As an example, a person may check whether the result of recognition by the OCR 10 is a correct answer or incorrect answer, and input the correct answer/incorrect answer information.

Below are the points of the threshold setting processing performed by the threshold setting processing device 20.
(1) Input a considerable number of sets of the recognition accuracy and the correct answer/incorrect answer information, as the learning data.
(2) For each of the post-stage processings 1 to N, set a target recognition rate required for the text code of the recognition result to be used by the post-stage processing unit 18. As the numeral of “N” of the post-stage processing is large, the target recognition rate is set to be high.
(3) Calculate a threshold for achieving the target recognition rate of each post-stage processing K (1≤K≤N) in an order starting from the post-stage processing N toward the post-stage processing 1.

The threshold setting processing device 20 includes a learning data input unit 22, a cumulative data calculation unit 24, a target recognition rate setting unit 26, and a threshold calculation unit 28.

The learning data input unit 22 inputs M pieces of learning data (sets of the recognition accuracy and the correct answer/incorrect answer information), and sorts the M pieces of learning data in an order of the recognition accuracy.

By using the sorted learning data, the cumulative data calculation unit 24 calculates the cumulative number of correct answers from the first learning data throughout the respective ranked pieces of learning data. Details will be described later.

The target recognition rate setting unit 26 sets a target recognition rate for each of the post-stage processings 1 to N. The target recognition rate of the post-stage processing K is a recognition rate that needs to be satisfied by the post-stage processing K. In an example, a user performs this setting. In addition, in the example of FIG. 8 to be described later, the target recognition rate may be automatically set.

Based on the cumulative number of correct answers calculated by the cumulative data calculation unit 24 and the target recognition rate of each post-stage processing set by the target recognition rate setting unit, the threshold calculation unit 28 calculates the N−1 thresholds for the division into the sections of the recognition accuracy which correspond to the respective post-stage processings.

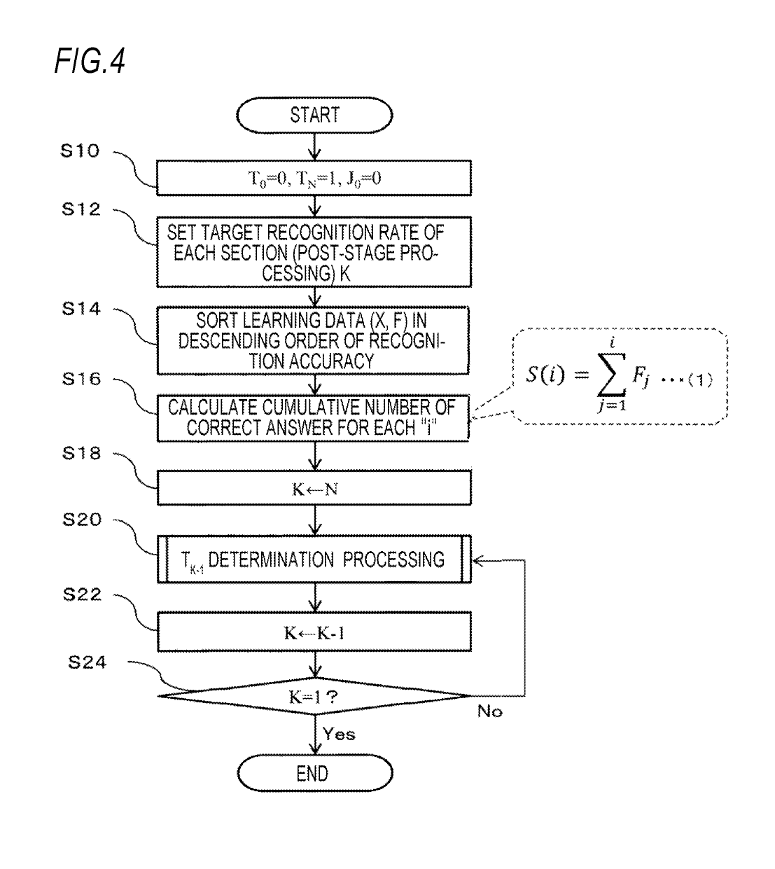

The threshold calculation method performed by the threshold calculation unit 28 will be described with reference to FIGS. 4 to 7.

In order to divide, into N sections, a range where the recognition accuracy X can lie, N−1 thresholds need to be determined. The N thresholds set here are referred to as T₁, T₂, . . . , and T_{N-1}. Even if the range where the recognition accuracy X can lie is set to a real number range from 0 to 1, the generality will not be lost. In the example described below, therefore, the range is defined in this manner. In addition, the number of each section (post-stage processing) will be represented by K.

The threshold calculation unit 28 performs the threshold calculation procedure illustrated in FIG. 4. In this procedure, first, both ends of the thresholds are set to T₀=0 and T_{N}=1, and an initial value Jo of a threshold index J_{K} is set to 0 (S10). In this example, an index j when T_{K}=X_{J} is expressed as j=J_{N-K}. That is, the procedure described below may be regarded as an algorithm for obtaining the threshold index J_{N-K} in order to obtain the threshold T_{K}. In addition, refers to the recognition accuracy of jth learning data. However, 1≤j≤M. As described later, it is assumed that when i>j, the pieces of learning data are sorted such that Xᵢ≤Xⱼ.

Subsequently, a target recognition rate Y_{K} for each section K is set (S12). The target recognition rate Y_{K} is a target recognition rate that needs to be achieved by the OCR 10 for the post-stage processing K corresponding to the section K (i.e., the correct answer rate of the character recognition). Here, the setting is performed such that as a number of the section K is large, the target recognition rate Y_{K} is high. The reason is described below.

That is, the determining system illustrated in FIG. 1 selects one of the post-stage processings 1 to N for the input image data, and the selected post-stage processing K outputs the final result of recognition by the determining system on the character string included in the input image data. Since a specific recognition rate required for the entire determining system needs to be satisfied (i.e., a higher recognition rate needs to be obtained as an average), the selected post-stage process K needs to satisfy the specific recognition rate. The post-stage processing K combines the result of recognition by the OCR 10 with the results of recognition by other units, so as to obtain the recognition result of the post-stage processing K. Here, as described above, the larger the number K is, the higher the dependency of the post-stage processing K on the result of recognition by the OCR 10 is. Accordingly, in order to make the recognition rate of the post-stage processing K satisfy the recognition rate required for the determining system, it is necessary to increase the recognition rate of the OCR 10 as the K becomes larger. Thus, the target recognition rate Y_{K} of the OCR 10 is set to be high as the K becomes larger.

For example, the user performs the setting of the target recognition rate Y_{K} in S12. In addition, the example where the target recognition rate Y_{K} is automatically set will be described later.

Subsequently, the threshold calculation unit 28 sorts the learning data in a descending order of the recognition accuracy (S14). As described above, individual learning data is a set of the recognition accuracy X and the correct/incorrect answer information F. Then, in the learning data group sorted in a descending order of the recognition accuracy X, the relationship that when i>j, Xᵢ≤Xⱼ is established. That is, as the value of the index j becomes larger, the recognition accuracy Xⱼ in the learning data j monotonously decreases. By sorting the learning data in advance using the recognition accuracy, the calculation of the cumulative number of correct answers S(i) to be described later is performed fast. Further, by calculating the cumulative number of correct answers S(i) in advance, the threshold calculation process is performed fast (it is unnecessary to add the number of pieces of learning data which are input to a desired post-stage processing each time).

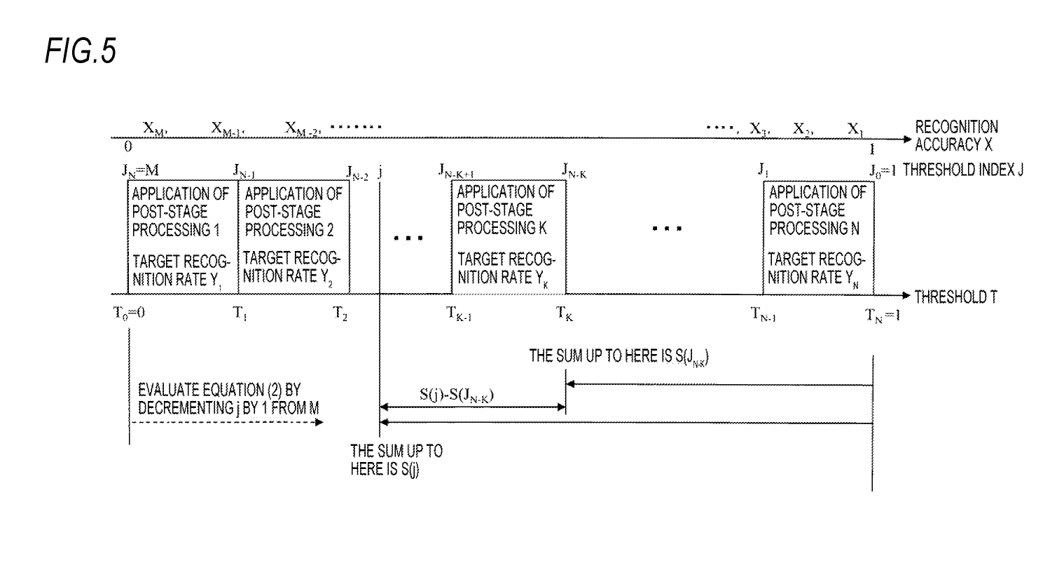

FIG. 5 schematically illustrates the relationship among the recognition accuracy Xⱼ in each learning data j, the threshold index J_{K}, the threshold T_{K}, and each section (post-stage processing) K, after the sorting. As illustrated in FIG. 5, the section K to which the post-stage processing K is applied is a section where the recognition accuracy X is equal to or more than T_{K-1} and less than T_{K}. The value of the target recognition rate set for the section K is Y_{K}. The recognition accuracy Xⱼ of each learning data j decreases as the index j is large. When the number of pieces of learning data is M, X_{M} corresponds to the minimum value of the recognition accuracy in the learning data group. In addition, from the definition, when j=J_{N-K}, the recognition accuracy Xⱼ becomes the threshold T_{K}.

In the procedure of FIG. 4, as illustrated in FIG. 5, the threshold T_{K} is determined in an order starting from K=N in a direction in which the K decreases, and in other words, the threshold index J. is determined in a direction in which “m” increases from 0.

Referring back to the procedure of FIG. 4, after S14, the threshold calculation unit 28 calculates the cumulative number of correct answers S(i) for each index “i” by using the illustrated equation (1) (S16). That is, the cumulative number of correct answers S(i) corresponds to the sum of pieces of correct/incorrect answer information Fⱼ (1 for a correct answer and 0 for an incorrect answer) in the respective pieces of learning data j where j ranges from 1 to i.

Subsequently, the threshold calculation unit 28 initializes the index K of the threshold value T_{K} to N (=the total number of post-stage processings) (S18).

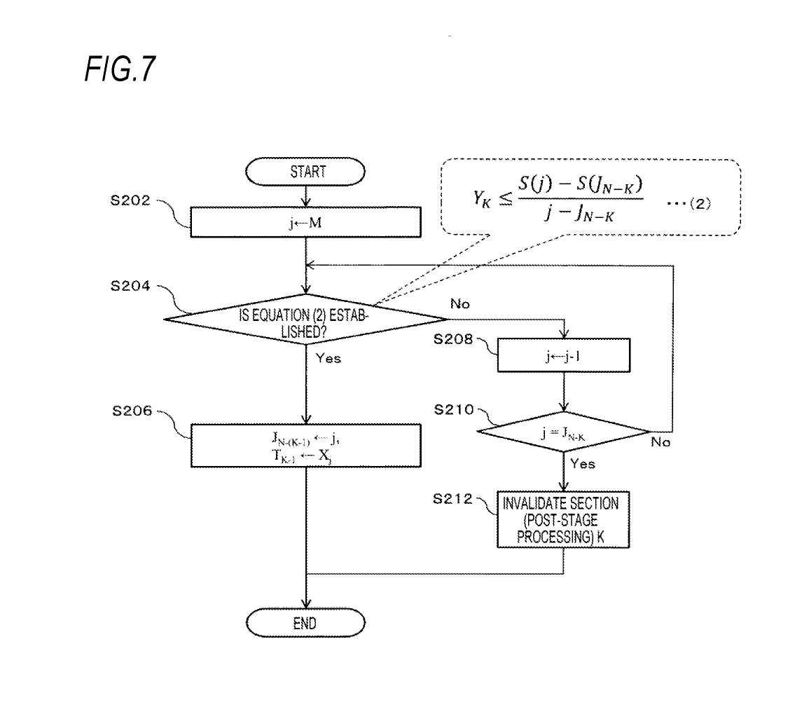

Subsequently, the threshold calculation unit 28 performs a processing for determining the threshold T_{K-1} (S20). In a section N to be processed in a first loop, the upper limit threshold T_{N} is set to 1, and in step S20, the lower limit threshold T_{N-1} of the section N is determined. A detailed example of the processing of S20 will be described later with reference to FIG. 7.

When the determination of the threshold T_{K-1} is ended, the threshold calculation unit 28 reduces the index K by 1 (S22), and determines whether K has reached 1 as a result (S24). When it is determined that K is not 1 (i.e., when K is equal to or more than 2), it is determined that the determination of all the thresholds has not been completed, and thus, the process returns to S20 to determine the threshold T_{K-1}. When it is determined that K has reached 1, it means that the determination of all the thresholds T₁ to T_{N-1} to be obtained has been completed, and thus, the process of FIG. 4 is ended.

Subsequently, with reference to FIG. 7, the detailed procedure of the processing (S20) for determining the threshold T_{K-1} will be described.

At the time of starting the procedure, the determination of the thresholds T_{N}, T_{N-1}, T_{N-2}, . . . , and T_{K} is completed.

In this procedure, first, the threshold calculation unit 28 initializes the index j of the cumulative number of correct answers S(j) to M (i.e., the total number of pieces of learning data) (S202).

Subsequently, the threshold calculation unit 28 determines whether the illustrated equation (2) is established (S204). With reference to FIG. 5, S(J_{N-K}) corresponds to the sum of correct/incorrect answer information F₁ in the learning data including the maximum value X₁ of the recognition accuracy up to correct/incorrect answer information F_{j(K)} in the learning data including the recognition accuracy X_{j(K)} corresponding to the threshold index J_{N-K} (=j(K)) of the already determined threshold T_{K}. Meanwhile, S(j) corresponds to the sum of the correct/incorrect answer information F₁ up to the correct/incorrect answer information Fⱼ corresponding to the index j larger than the threshold index J_{N-K}. The difference of both (S(j)−S(J_{N-K})) is the total number of correct answers in the section from J_{N-K} to j, and when the total number is divided by (j−J_{N-K}), the correct answer rate of the OCR 10 in the section may be obtained.

When the correct answer rate is equal to or higher than the target recognition rate Y_{K} of the section K which is currently subjected to the threshold determination process, the section from J_{N-K} to j satisfies the condition of the target recognition rate for the section K (“Yes” as the determination result of S204). In this case, the threshold calculation unit 28 adopts the recognition accuracy Xⱼ corresponding to j at this time as the threshold T_{K-1} that defines the lower limit of the recognition accuracy of the section K (S206). Further, at this time, the j is stored as a threshold index J_{N-K+1} corresponding to the threshold T_{K-1}.

When the determination result of S204 is “No,” the threshold calculation unit 28 decrements the index j by 1 (S208), and determines whether the new decremented index j reaches the threshold index J_{N-K} corresponding to the upper limit of the section K (S210). When the determination result is “No,” the threshold calculation unit 28 returns to S204, and evaluates the expression (2) for the new index j.

The evaluation of the expression (2) is repeatedly performed in an order starting from the maximum value M by decrementing the index j by 1 (S208), so that when j reaches J_{N-K} (“Yes” as the determination result of S210), there exists no recognition accuracy X that can belong to the section K. In this case, the threshold calculation unit 28 invalidates the post-stage processing K corresponding to the section K (S212). That is, the post-stage processing K is not used in the determination processing performed by the determining system on actual input image data using the threshold group set in the threshold setting processing.

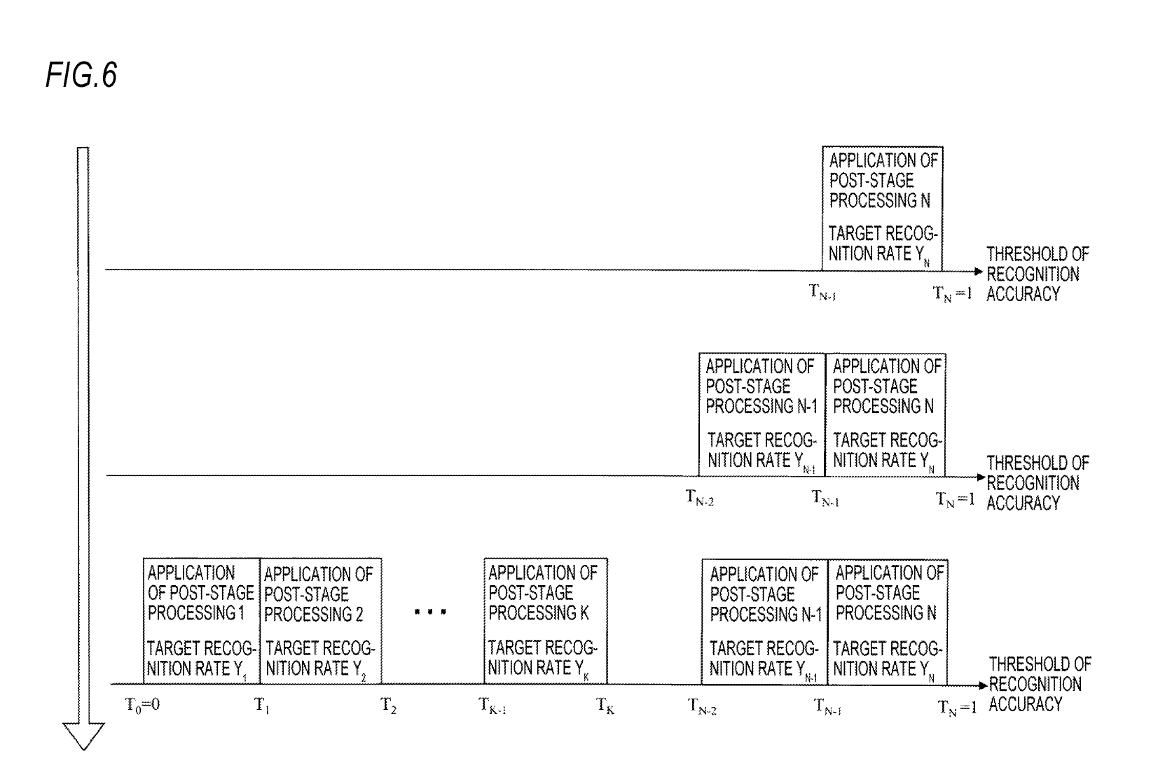

As described above, in the procedure of FIG. 7, since the evaluation is progressed in an order starting from the maximum value M in a direction in which the index j decreases, the section K determined by the procedure corresponds to the section with the maximum width satisfying the target recognition rate Y_{K}. In the procedure of FIG. 4, since the division of the section K (the lower limit threshold T_{K-1}) is determined in an order starting from the section K where the corresponding recognition accuracy X (corresponding target recognition rate Y_{K} in another viewpoint) is high, the section with the maximum width satisfying the target recognition rate Y_{K} is secured in an order starting from the section K where the recognition accuracy X is high. For example, in the example of FIG. 6, first, the lower limit threshold T_{N-1} of the section N is determined such that the section N of the post-stage processing N where the corresponding recognition accuracy is the highest has the maximum width in the range satisfying the target recognition rate Y_{N}. Subsequently, a threshold T_{N-2} is determined such that a section N−1 has the maximum width in the range satisfying the target recognition rate Y_{N-1}. This determination processing is repeated until an upper limit threshold T₁ of a section 1 where the corresponding recognition accuracy is the lowest (i.e., a lower limit threshold of a section 2) is determined.

As the post-stage processing K corresponds to the section K where the recognition accuracy (or target recognition rate Y_{K}) is relatively high, the dependency on the OCR 10 is high. That is, the dependency on one or more “other units” that cost higher than the OCR 10 is low. Thus, in the procedure of FIG. 4, the section of the maximum width satisfying the target recognition rate Y_{K} is secured in an order starting from the relatively low-cost post-stage processing K. As a result, the relatively low-cost post-stage processing K is easily selected at the time of processing the input image data, and the processing cost of the entire determining system is reduced (in theory, the cost is minimized under the given learning data group).

The configuration and the operation of the threshold setting processing device 20 according to the present exemplary embodiment have been described. Subsequently, with reference to FIG. 8, descriptions will be made on an example where based on a specific example of the determining system provided with three post-stage processing units 18 (post-stage processings 1 to 3), the target recognition rate of the section corresponding to each post-stage processing unit 18 is automatically determined.

FIG. 8 illustrates post-stage processing units 18-1, 18-2, and 18-3 of the determining system according to the specific example, the OCR 10 that supplies the recognition results to the post-stage processing units 18-1, 18-2, and 18-3, and the separation processing unit 16. FIG. 8 further illustrates manual input devices 30-1, 30-2, and 30-3 that provide the determining system with input image data by a human operator (which will be collectively referred to as a manual input device 30 when the devices need not to be discriminated from each other).

The manual input device 30 displays input image data to be subjected to the character recognition on a screen, receives an input of a recognition result of a character string included in the input image data from the human operator, and transmits the character string of the received recognition result to the post-stage processing units 18-1, 18-2, and 18-3. The manual input device 30 is, for example, application software on each operator's personal computer which is connected to the determining system via the Internet.

The post-stage processing unit 18-3 (post-stage processing 3) corresponds to the section where the recognition accuracy (target recognition rate in another viewpoint) is the highest, among the three post-stage processing units 18. In this example, the post-stage processing unit 18-3 receives the result of recognition by the OCR 10, and outputs the recognition result as it is as its own recognition result.

The post-stage processing unit 18-2 (post-stage processing 2) corresponds to the section where the recognition accuracy is intermediate, among the three post-stage processing units 18. In addition to the result of recognition by the OCR 10, a character string of a recognition result by each operator is input to the post-stage processing unit 18-2 from the manual input devices 30-1 and 30-2. When the post-stage processing unit 18-2 is selected by the separation processing unit 16 according to the recognition accuracy obtained by the OCR 10, the post-stage processing unit 18-2 supplies the input image data to the manual input device 30-1, and acquires the character string (text code) input by the operator of the manual input device 30-1 as the recognition result of the input image data. Then, the post-stage processing unit 18-2 compares the recognition result obtained from the OCR 10 and the recognition result obtained from the manual input device 30-1 with each other, and when both match each other, the post-stage processing unit 18-2 outputs the matching recognition result as its recognition result. Meanwhile, when both do not match each other, the post-stage processing unit 18-2 supplies the input image data to another manual input device 30-2, acquires the character string input by the operator of the manual input device 30-2 as the recognition result of the input image data, and outputs the character string as its recognition result. In this case, the operator of the manual input device 30-2 may be a person assumed to recognize the character string in the input image data with a higher recognition accuracy than the operator of the manual input device 30-1 (e.g., a person who achieved good performance in the past).

The post-stage processing unit 18-1 (post-stage processing 1) corresponds to the section where the recognition accuracy is the lowest, among the three post-stage processing units 18. The post-stage processing unit 18-1 performs the same processing as performed in the post-stage processing unit 18-2, by using the recognition results input by the respective operators of the manual input devices 30-1, 30-2, and 30-3, without using the result of recognition by the OCR 10. That is, when the post-stage processing unit 18-1 is selected by the separation processing unit 16 according to the recognition accuracy obtained by the OCR 10, the post-stage processing unit 18-1 supplies the input image data to the manual input devices 30-1 and 30-3, and acquires the character string input by the operator of each of the manual input devices 30-1 and 30-3 as the recognition result of the input image data. Then, the post-stage processing unit 18-1 compares the recognition results obtained from the manual input devices 30-1 and 30-3 with each other, and when both match each other, the post-stage processing unit 18-1 outputs the matching recognition result as its recognition result. Meanwhile, when both do not match each other, the post-stage processing unit 18-1 supplies the input image data to another manual input device 30-2, acquires the character string input by the operator of the manual input device 30-2 as the recognition result of the input image data, and outputs the character string as its recognition result. In this case, the operator of the manual input device 30-2 may be a person assumed to recognize the character string in the input image data with a higher recognition accuracy than the operator of each of the manual input devices 30-1 and 30-3 (e.g., a person who achieved good performance in the past).

The three sections 1, 2, and 3 of the recognition accuracy which are associated with the three post-stage processing units 18-1, 18-2, and 18-3 are divided by two thresholds Ti and T₂ (T₁<T₂). When the recognition accuracy X output from the OCR 10 is less than T₁, the separation processing unit 16 selects the post-stage processing unit 18-1. When the recognition accuracy X is equal to or more than T₁ and less than T₂, the separation processing unit 16 selects the post-stage processing unit 18-2. When the recognition accuracy X is equal to or more than T₂, the separation processing unit 16 selects the post-stage processing unit 18-3.

The threshold setting processing device 20 calculates the target recognition rates Y₁, Y₂, and Y₃ of the OCR 10 which correspond to the section 1 (T₁>X), the section 2 (T₂>X≥T₁), and the section 3 (X≥T₂), respectively, corresponding to the three post-stage processing units 18-1, 18-2, and 18-3, as follows.

First, the target recognition rate of the determining system is referred to as “R” (i.e., the target value of the correct answer rate of the final output of the determining system). Since the post-stage processing unit 18-1 does not use the recognition result of the OCR 10 at all, the recognition rate of the OCR 10 may be 0. Thus, the threshold setting processing device 20 performs a setting such that the target recognition rate Y₁=0. The post-stage processing unit 18-1 itself satisfies the target recognition rate R of the determining system by appropriately selecting the operator of each of the manual input devices 30-1, 30-2, and 30-3.

Meanwhile, since the post-stage processing unit 18-3 uses the result of recognition by the OCR 10 as it is as its own output, the target recognition rate Y₃=R.

For the remaining post-stage processing unit 18-2, the target recognition rate Y₂ of the OCR 10 is calculated as follows.

First, an error rate when a person enters data (i.e., performs a process of recognizing a character string included in the input image data and inputting the character string to the manual input device 30) is λ. In other words, the correct answer rate (recognition rate) of data entered by a person is (1−λ). Meanwhile, an error rate of the result of recognition by the OCR 10 is ω. That is, the correct answer rate (recognition rate) of the OCR 10 is (1−ω). An approximate value of the error rate of the comparison process by the post-stage processing unit 18-2 between the recognition results of the OCR 10 and the person becomes λω. Considering that the post-stage processing unit 18-2 needs to satisfy the target recognition rate R of the determining system, the relationship of λω=(1−R) is established. Accordingly, in a case where the post-stage processing unit 18-2 is selected, the target recognition rate Y₂ of the OCR 10 may be regarded as being equal to (1−ω), and thus, the Y₂ is finally calculated from the error rate λ of the known person and the target recognition rate R of the determining system as follows.

Y₂=1−ω=1−(1−R)/λ

The threshold setting processing device 20 may calculate the threshold Y₂ according to this equation.

The exemplary embodiment described above is merely an example for implementing the present disclosure.

In the example above, the cumulative number of correct answers S(j) is used for determining the thresholds. However, the cumulative number of errors may be used instead. The number of errors is the number of learning data in which Fⱼ=0. In addition, even when a cumulative correct answer rate (recognition rate) obtained by dividing the cumulative number of correct answers by the number of samples is used instead of the cumulative number of correct answers S(j) (or the number of errors), the same processing is possible as performed when the cumulative number of correct answers is used. In addition, it may be appropriately determined whether each section K includes the upper or lower limit threshold T_{K} or T_{K-1}, without being limited to that described above.

In addition, in the exemplary embodiment described above, the learning data which is a set of the recognition accuracy X and the correct/incorrect answer information F is input to the threshold setting processing device 20. However, this is merely an example. Instead, information of a cumulative result obtained by accumulating the correct/incorrect answer information F in an ascending or a descending order of the recognition accuracy X up to a recognition accuracy Xj in question may be calculated in advance, and a set of the information and the recognition accuracy Xⱼ may be input as the learning data to the threshold setting processing device 20. Here, as for the information of the cumulative result, any one of the above-described cumulative number of correct answers, cumulative number of errors, cumulative correct answer rate, and cumulative error rate may be used.

In addition, in the exemplary embodiment described above, the determination system recognizes a character string in the input image data. However, the technique of the exemplary embodiment described above may be applied to a general determination system which determines the contents of input data and outputs the determination result, in addition to performing the character recognition. That is, the determining system to which the present disclosure is applied has only to include a primary determining unit (corresponding to the OCR 10) that determines the contents of input data, and multiple post-stage processing units that each combines the determination result from the primary determining unit with determination results of 0 or more other determining units (e.g., a person or a determining unit providing a higher accuracy but requiring a higher cost than the primary determining unit) so as to obtain the result of determination of the contents of the data. This determining system includes a unit for obtaining a determination accuracy (corresponding to the recognition accuracy for the character recognition) on the determination result from the primary determining unit, and determines which of the multiple post-stage processing units is to be used according to the determination accuracy. That is, the post-stage processing units are associated with sections of different degrees of determination accuracy, respectively, and the post-stage processing unit corresponding to the section to which the determination accuracy of the determination by the primary determining unit belongs selectively operates.

The above-described determining system and threshold setting processing device 20 may be configured by hardware logic circuits, in an example. As another example, the determining system and the threshold setting processing device 20 may be implemented by, for example, causing an equipped computer to execute programs representing the functions of the respective functional modules in the system or device. Here, the computer has a circuit configuration where as hardware, for example, a processor such as a CPU, a memory (primary storage) such as a random access memory (RAM) or a read only memory (ROM), an HDD controller for controlling a hard disk drive (HDD), various input/output (I/O) interfaces, and a network interface for controlling a connection with, for example, a local area network are connected to each other via, for example, a bus. In addition, for example, a disk drive for reading and/or writing with respect to a portable disk recording medium such as a CD or DVD, and a memory reader/writer for reading and/or writing with respect to portable nonvolatile recording media of various standards such as a flash memory may be connected to the bus via, for example, the I/O interfaces. The programs describing the processing contents of the respective functional modules described above are saved in a fixed storage device such as a hard disk drive and installed in a computer, via a recording medium such as a CD or DVD or via a communication unit such as a network. The programs stored in the fixed storage device are read into the RAM and executed by the processor such as the CPU, so that the functional module group described above is implemented. In addition, the determining system and the threshold setting processing device 20 may be configured by a combination of software and hardware.

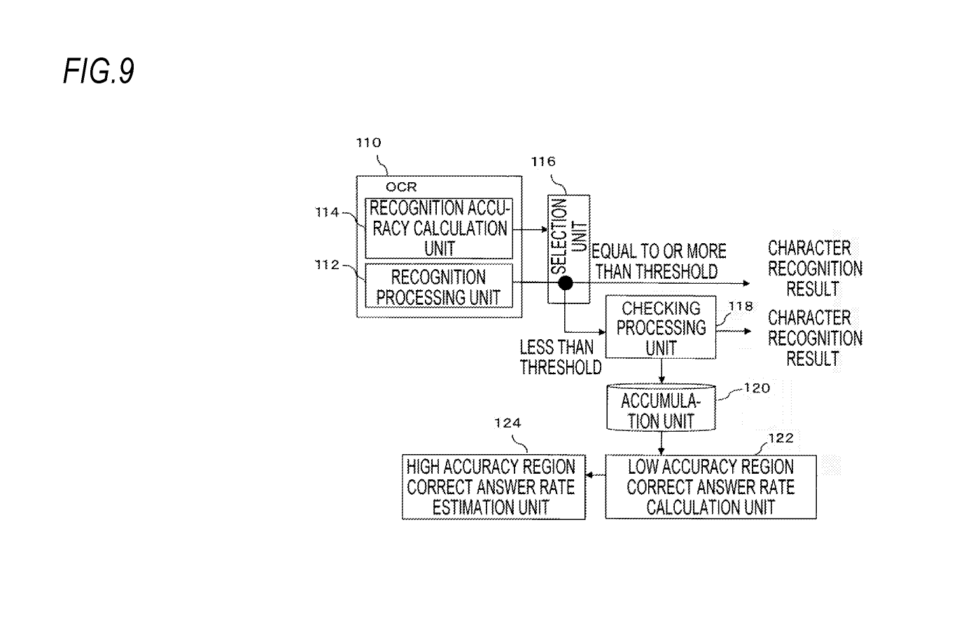

FIG. 9 illustrates another exemplary embodiment of the information processing apparatus 20 according to the present disclosure.

This information processing apparatus determines the character string included in the input image data by the OCR 110 and a checking processing unit 118.

The OCR 110 includes a recognition processing unit 112 and a recognition accuracy calculation unit 114. The recognition processing unit 112 recognizes the character string included in the input image data by performing a well-known OCR (optical character recognition) processing on the input image data. The recognition processing unit 112 outputs a text code representing the recognized character string. The recognition accuracy calculation unit 114 calculates the recognition accuracy on the text code recognized from the input image data. The recognition accuracy refers to a degree of an accuracy indicating that the text code of the recognition result accurately represents the character string (which may be a handwriting) included in the input image data. As the recognition accuracy is high, the text code of the recognition result is highly likely to be correct (that is, the text code accurately represents the character string in the input image data). Hereinafter, the possibility that the recognition result is a correct answer will be called a recognition rate or correct answer rate. The OCR 110 may output multiple different recognition results on the input image data in association with degrees of the recognition accuracy in a descending order of the recognition accuracy. In addition, the unit in which the OCR 110 performs the character recognition (i.e., the unit in which the recognition result is output) is not specifically limited, and may be, for example, any of a character unit, a line or column unit (horizontal or vertical writing), a page unit, and a document unit.

In addition, the character recognition method or the recognition accuracy calculation method which is used by the OCR 110 is not specifically limited, and any one of the methods of related art including the methods disclosed in JP-A-05-274467, JP-A-2010-073201, JP-A-05-040853, JP-A-05-020500, JP-A-05-290169, and JP-A-08-101880 and methods to be developed in the future may be used.

The selection unit 116 controls the output of the character recognition result based on the recognition accuracy calculated by the recognition accuracy calculation unit 114 on the character recognition result (text code) of the recognition processing unit 112. That is, when the recognition accuracy is equal to or higher than a specific threshold, the selection unit 116 outputs the character recognition result as the final result of character recognition by the information processing apparatus itself. When the recognition accuracy is equal to or higher than the threshold, the selection unit 116 believes that the recognition of the recognition processing unit 112 is correct.

Meanwhile, when the recognition accuracy is less than the threshold, the selection unit 116 transfers the character recognition result and the input image data corresponding to the character recognition result to the checking processing unit 118, to check whether the character recognition result is accurate.

In an example, the checking processing unit 118 presents the input image data and the character recognition result to a person, as a human being, in charge of the checking, and causes the person to check whether the character recognition result is accurate as the character string in the input image data. The person in charge of the checking may be operating a terminal connected to the information processing apparatus via a network such as the Internet, and in this case, the checking processing unit 118 sends screen information displaying the input image data and the character recognition result (e.g., a webpage) to the terminal, and receives an input by the person in charge of the checking in response to the screen information. When it is determined that the character recognition result is accurate, the person in charge of the checking performs an input in that effect to the checking processing unit 118, and accordingly, the checking processing unit 118 outputs the character recognition result received from the selection unit 116 as the final result of character recognition by the information processing apparatus itself. Further, at this time, the checking processing unit 118 accumulates checking result information indicating that the result of character recognition by the recognition processing unit 112 is a correct answer, in an accumulation unit 120.

In addition, when it is determined that the character recognition result received from the selection unit 116 is inaccurate as the character string in the input image data, the person in charge of the checking performs an input for correcting the character recognition result to the checking processing unit 118. Accordingly, the checking processing unit 118 outputs the corrected character recognition result as the final result of character recognition by the information processing apparatus itself. Further, at this time, the checking processing unit 118 accumulates checking result information indicating that the result of character recognition by the recognition processing unit 112 is an incorrect answer, in the accumulation unit 120.

A case where a human being checks the result of character recognition by the OCR 110 has been described as an example. However, the checking may be performed by using another OCR which is more accurate than, for example, the OCR 110 but requires a relatively high cost for the character recognition (e.g., a high-precision charged OCR service operated on the Internet by an operator different from the user of the information processing apparatus). In this case, the checking processing unit 118 causes the another OCR to recognize the input image data, receives the recognition result, and outputs the received recognition result as the final result of character recognition by the corresponding information processing apparatus itself. Further, the checking processing unit 118 compares the result of character recognition by the recognition processing unit 112 which has been received from the selection unit 116 with the recognition result received from the another OCR. When both match each other, the checking processing unit 118 accumulates checking result information indicating that the result of character recognition by the recognition processing unit 112 is a correct answer, in the accumulation unit 120. When both do not match each other, the checking processing unit 118 accumulates checking result information indicating that the result of character recognition by the recognition processing unit 112 is an incorrect answer, in the accumulation unit 120.

As described above, the checking processing unit 118 accumulates the checking result information indicating that the result of character recognition by the recognition processing unit 112 is a correct or incorrect answer, in an accumulation unit 120. Here, the checking processing unit 118 performs the determination of a correct/incorrect answer on the result of character recognition by the recognition processing unit 112, when the recognition accuracy corresponding to the character recognition result is less than the threshold. Accordingly, the checking result information accumulated in the accumulation unit 120 is a result of the determination of a correct/incorrect answer on the character recognition result where the recognition accuracy is less than the threshold.

Based on the checking result information group accumulated in the accumulation unit 120, that is, the information of a correct/incorrect answer on the character recognition result where the recognition accuracy is less than the threshold, a low accuracy region correct answer rate calculation unit 122 calculates the correct answer rate of the recognition processing unit 112 on a low accuracy region, that is, a recognition accuracy range which is less than the threshold. For example, this correct answer rate may be calculated by dividing the number of pieces of checking result information indicating a correct answer by the total number of pieces of checking result information to be subjected to the correct answer rate calculation.

Based on the correct answer rate of the low accuracy region calculated by the low accuracy region correct answer rate calculation unit 122, a high accuracy region correct answer rate estimation unit 124 calculates the correct answer rate of the recognition processing unit 112 on a high accuracy region, that is, a recognition accuracy range which is equal to or more than the threshold. Hereinafter, an example of the estimation performed by the high accuracy region correct answer rate estimation unit 124 will be described.

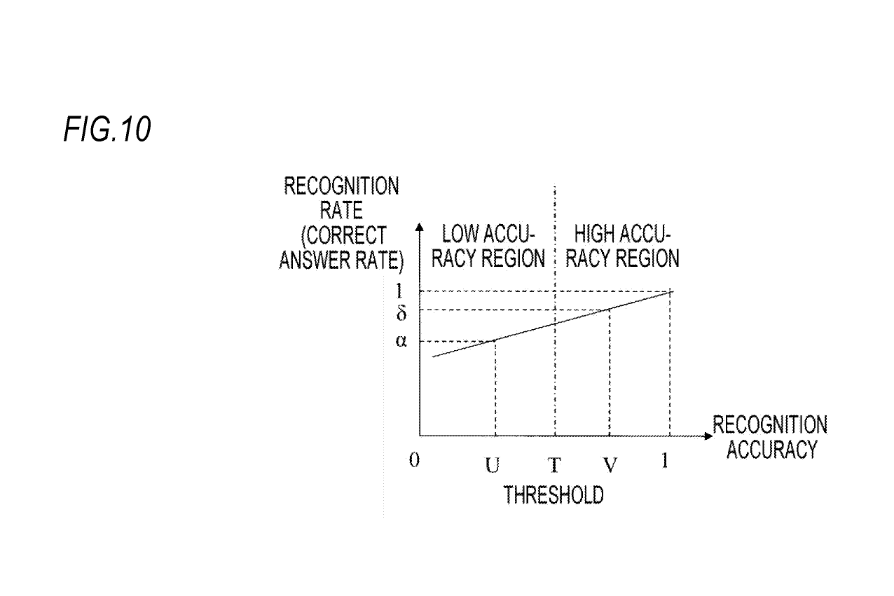

A first example will be described with reference to FIG. 10.

The recognition accuracy is set to a real number value from 0 to 1, a representative value of the low accuracy region is referred to as U, and a representative value of the high accuracy region is referred to as V. In a case where a median value of each region is used as the representative value of the region, when the threshold used by the selection unit 116 is T, U=T/2, and V=(T+1)/2. In the example of FIG. 10, assuming that the correct answer rate (recognition rate) is 1 when the recognition accuracy is 1, and the correct answer rate a of the low accuracy region calculated by the low accuracy region correct answer rate calculation unit 122 corresponds to the correct answer rate at the representative value U, a correct answer rate δ of the high accuracy region at the representative value V is estimated by linear interpolation. That is, the high accuracy region correct rate estimation unit 124 obtains the correct answer rate δ by using the following equation (1).

$$\begin{matrix}[ Equation 1 ] & \\ δ = \frac{( 1 - α ) ( V - U )}{1 - U} + α & ( 1 )\end{matrix}$$

In the descriptions above, the median values of the respective low and high accuracy regions are used as the representative values U and V of the regions. However, this is merely an example. Instead, representative values of a frequency distribution (or a probability density function obtained from the frequency distribution) of the recognition accuracy in the respective regions may be used as the U and V. That is, the recognition accuracy calculated by the recognition accuracy calculation unit 114 for each input image data may be accumulated, and by using the accumulated information, the frequency (occurrence rate) of the recognition accuracy that belongs to each section of the recognition accuracy may be obtained, and from a frequency distribution (histogram) that can be generated from the frequency, the representative values of the high and low accuracy regions may be obtained. In addition, since only the information of the low accuracy region is accumulated in the accumulation unit 120, the output of the recognition accuracy calculation unit 114 is accumulated separately from the information of the low accuracy region, in an order to obtain the distribution of the recognition accuracy in the entire range. As for the representative value of the frequency distribution, for example, an average value, a median value, or a mode value may be used.

In addition, the representative values U and V as average values may be obtained by using the probability density function p(x) of the recognition accuracy and the following equation (2).

$$\begin{matrix}[ Equation 2 ] & \\ U = \frac{{\int }_{0}^{T} xp ( x ) dx}{{\int }_{0}^{T} p ( x ) dx} , V = \frac{{\int }_{T}^{1} xp ( x ) dx}{{\int }_{T}^{1} p ( x ) dx} & ( 2 )\end{matrix}$$

Here, the probability density function p(x) may be obtained as follows.

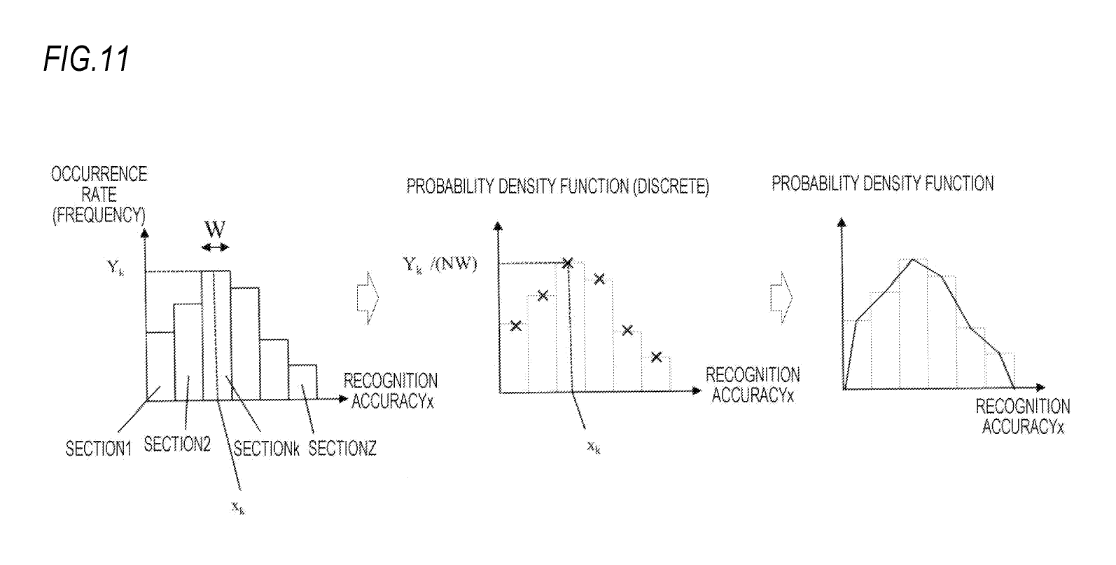

That is, as illustrated in FIG. 11, first, the recognition accuracy x is divided into multiple sections. The number of the sections is referred to as Z, and the width of a section is referred to as W. An index of each section is referred to as k. The index “k” is an integer which is 1 or more and Z or less. The value of the center of the section k (i.e., the value obtained by adding up the lower and upper limits of the section and dividing the obtained value by 2) is a section representative xₖ. The recognition accuracy obtained by the recognition accuracy calculation unit 114 for each input image data is accumulated, and from the accumulated information, an occurrence frequency (frequency) Yₖ of the recognition accuracy which belongs to each section k is obtained. When the number of pieces of input image data (i.e., the number of recognition accuracies) is N, the probability density value p(x) at the section representative value is obtained by the following equation: p(xₖ)=Yₖ/NW.

This is a discrete probability density function. A continuous function obtained by interpolating the function above using a well-known interpolation method may be used as the probability density function p(x).

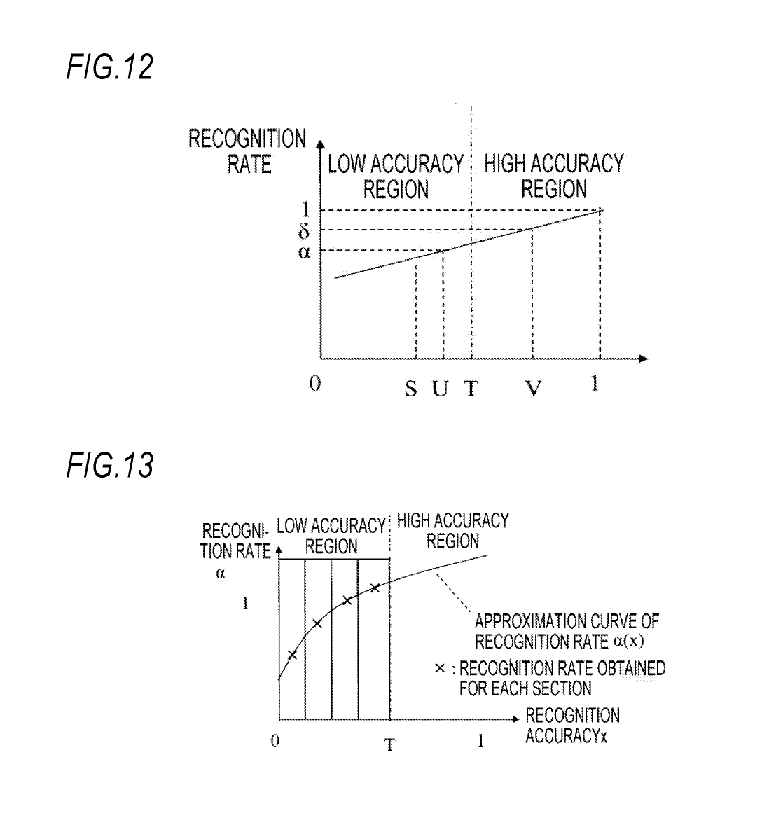

An improvement of the estimation method of the high accuracy region correct answer rate estimation unit 124 described above using FIG. 10 will be described below with reference to FIG. 12.

In the example of FIG. 10, the correct answer rate in the high accuracy region is calculated using the correct answer rate in the entire low accuracy region. However, the correct answer rate in the region where the recognition accuracy is very low has a low relevance to the correct answer rate in the high accuracy region. Thus, in this improved method, the correct answer rate of the high accuracy region is estimated based on the correct answer rate only for a region close to the threshold T, rather than for the entire low accuracy region.

That is, a region lower limit value S satisfying 1<S<T is determined in advance, and the low accuracy region correct answer rate calculation unit 122 calculates the correct answer rate a only from checking result information where the recognition accuracy x satisfies S≤x≤T, in the pieces of checking result information accumulated in the accumulation unit 120. The method of determining the value of S is not specifically limited. For example, a value which corresponds to a fixed ratio less than 1 with respect to the threshold value T may be set in advance as “S.” In addition, the data (checking result information) in the accumulation unit 120 may be selected in an order in a direction in which the value of the recognition accuracy x decreases from the threshold T, and the recognition accuracy x when the number of selected data becomes a predetermined ratio to the total number of data which is equal to or less than the threshold T may be set as the lower limit value “S.”

The high accuracy region correct answer rate estimation unit 124 obtains the representative value U of the recognition accuracy in the region where the recognition accuracy ranges from S to T, in the same manner as used in the exemplary embodiment described above. Then, assuming that the correct answer rate a of the region is the value at the representative value U, the high accuracy region correct answer rate estimation unit 124 calculates the correct answer rate δ of the high accuracy region by using the equation (1) above.

In this improved method, since the correct answer rate of the high accuracy region is estimated from the correct answer rate of the region, in the low accuracy region, close to the high accuracy region, the correct answer rate of the high accuracy region may be accurately estimated, as compared with a case where the correct answer rate of the high accuracy region is estimated from the correct answer rate of the entire low accuracy region.

Another modification will be described with reference to FIG. 13.

In this modification, as illustrated in FIG. 13, the low accuracy region correct answer rate calculation unit 122 divides the low accuracy region into N small regions (N is an integer equal to or greater than 2), and calculates the correct answer rate for each small region from the checking result information accumulated in the accumulation unit 120 and corresponding to the recognition accuracy that belongs to the small region. In the example of FIG. 13, the low accuracy region is divided into four small regions. However, this is merely an example. Then, the low accuracy region correct answer rate calculation unit 122 assumes that the correct answer rate a of the small region is a correct answer rate at the representative value x of the small region (illustrated as a symbol “X” in FIG. 13) (i.e., the accuracy of the center between the upper and lower limits of the small region).

The high accuracy region correct answer rate estimation unit 124 estimates a function a(x) by a well-known method such as polynomial approximation or curve fitting, assuming that the correct answer rate a becomes the function a(x) of the recognition accuracy x. Then, with the function α(x), the high accuracy region correct answer rate estimation unit 124 estimates the correct answer rate δ of the high accuracy region by the following equation (3).

$$\begin{matrix}[ Equation 3 ] & \\ δ = \frac{1}{1 - T} {\int }_{T}^{1} α ( x ) dx & ( 3 )\end{matrix}$$

In addition, the high accuracy region correct answer rate estimation unit 124 may estimate the correct answer rate δ of the high accuracy region by using the following equation (4), instead of the equation (3).

$$\begin{matrix}[ Equation 4 ] & \\ δ = \frac{{\int }_{T}^{1} α ( x ) p ( x ) dx}{{\int }_{T}^{1} p ( x ) dx} & ( 4 )\end{matrix}$$

In the equation (4), p(x) refers to the probability density function p(x) described above. In other words, the equation (3) is an equation obtained assuming that the probability density function p(x) is a uniform distribution.

In addition, the equation (3) or (4) is to obtain the correct answer rate for the high accuracy region, that is, the entire range in which the recognition accuracy x ranges from the threshold T to 1. By generalizing this, the high accuracy region correct answer rate estimation unit 124 may estimate a correction answer rate for the range of T1≤x≤T2 (however, T≤T1≤T2) within the high accuracy region by the following equation (5).

$$\begin{matrix}[ Equation 5 ] & \\ δ = \frac{{\int }_{{T}_{1}}^{{T}_{2}} α ( x ) p ( x ) dx}{{\int }_{{T}_{1}}^{{T}_{2}} p ( x ) dx} & ( 5 )\end{matrix}$$

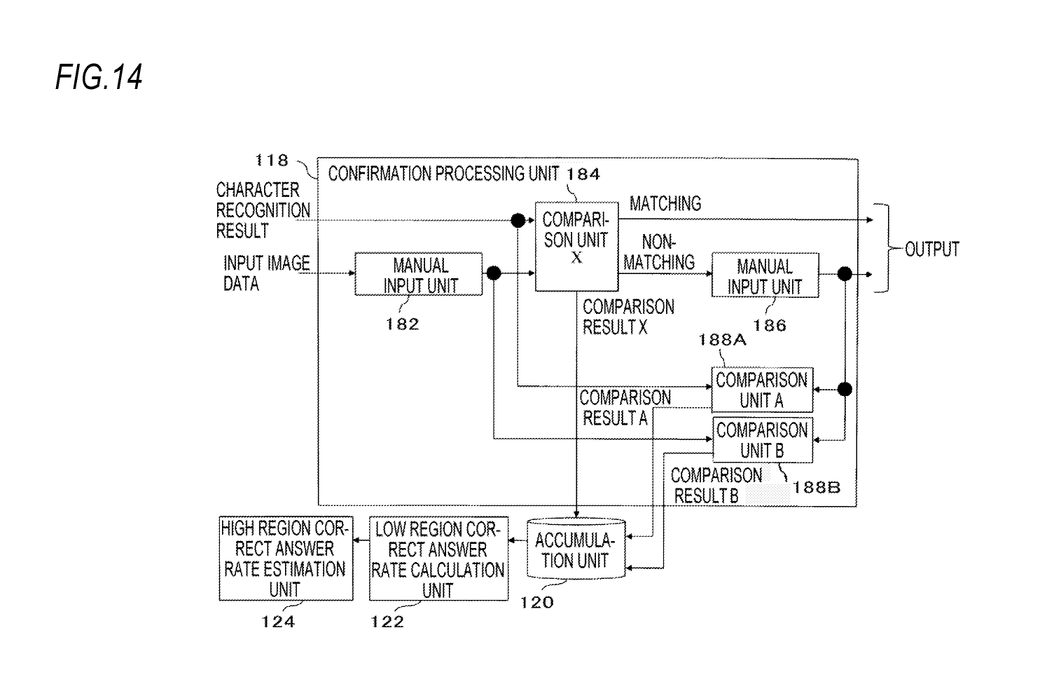

Another modification will be described with reference to FIG. 14. FIG. 14 illustrates an example of the internal configuration of the checking processing unit 118, the accumulation unit 120, the low accuracy region correct answer rate calculation unit 122, and the high accuracy region correct answer rate estimation unit 124, in the information processing apparatus of the present modification. The information processing apparatus of the present modification also includes the OCR 110 and the selection unit 116 as in FIG. 9.

When the recognition accuracy calculated by the recognition accuracy calculation unit 114 on the input image data is less than the threshold, the selection unit 116 instructs the checking processing unit 118 to perform the processing. At this time, the selection unit 116 inputs the input image data and the result of character recognition by the recognition processing unit 112 on the input image data to the checking processing unit 118. The character recognition result is transferred to a comparison unit 184, and the input image data is transferred to a manual input unit 182.

The manual input unit 182 presents the image represented by the transferred input image data to an inputting person as a human being, and receives an input of a character string read by the inputting person from the image. The manual input unit 182 may be regard as a character recognition unit provided with a human being as a character recognition engine. The inputting person who performs the character recognition may be present at a remote position from the information processing apparatus via a network such as the Internet. In this case, the manual input unit 182 provides the terminal operated by the inputting person with the image represented by the input image data via the network, for example, in a webpage form, and receives the character string of the recognition result input by the user in response via the network. The character string received by the manual input unit 182 from the inputting person is input to the comparison unit 184.

The comparison unit X 184 compares (i.e., collates) the result of character recognition by the recognition processing unit 112 of the OCR 110 and the character string received by the manual input unit 182 from the inputting person with each other, so as to determine whether both match (i.e., are consistent with) each other or not (do not match each other). When both match each other, the comparison unit 184 outputs the matching determination result as the final result of character recognition by the information processing apparatus. When both do not match each other, the comparison unit 184 causes the manual input unit 186 to perform the processing. Further, the comparison unit 184 accumulates a comparison result X which is the comparison result above (i.e., a value indicating “matching” or “non-matching”) in the accumulation unit 120. The value of the comparison result X is a binary value indicating the matching or non-matching. Hereinafter, as an example, for the convenience of calculation, it is assumed that the value of the comparison result X indicates “1” for the matching, and indicates “0” for the non-matching (the same applies to a case of comparison units 188A and 188B to be described later). Since the comparison result X accumulated in the accumulation unit 120 is associated with identification information “i” of the input image data (e.g., a serial number sequentially assigned to each input data), it may be identified to which input image data the comparison result corresponds.

When the manual input unit 186 receives a trigger of the case of the non-matching from the comparison unit 184, the inputting person of the manual input unit 182 presents the image represented by the input image data to a second inputting person, and receives an input of a character string read by the second inputting person from the image. Then, the character string received by the manual input unit 186 from the second inputting person is output as the final result of character recognition by the information processing apparatus on the input image data.

While the manual input unit 186 may always perform the process of receiving the input of the character string from the second inputting person on the same input image data in parallel with the OCR 110 and the manual input unit 182, this process may be performed only when the determination result from the comparison result 184 is the non-matching. As a result, the cost for the processing of the manual input unit 186 (e.g., the cost for the second inputting person) is reduced.

The OCR 110, the manual input unit 182, the comparison unit 184, and the manual input unit 186 are recognition mechanisms in charge of the character recognition on the input image data for the low accuracy region, that is, the region where the recognition accuracy is less than the threshold.

Meanwhile, the comparison units 188A and 188B to be described below, the accumulation unit 120, and the low accuracy region correct answer rate calculation unit 122 accumulate a large number of determination results obtained by the recognition mechanisms, and calculate the correct answer rates of the OCR 110 and the manual input unit 182, respectively, in the low accuracy region, based on the accumulated information. In addition, the correct answer rates of the recognition mechanisms for the low accuracy region may be calculated.

That is, first, the comparison unit 188A compares the character recognition result of the OCR 110 and the character string received by the manual input unit 186 with each other, and accumulates the comparison result (comparison result A) in association with the identification information “i” of the input image data in the accumulation unit 120. The comparison unit 188B compares the determination result from the manual input unit 182 and the determination result from the manual input unit 186 with each other, and accumulates the comparison result (comparison result B) in association with the identification information “i” of the input image data in the accumulation unit 120.

In the accumulation unit 120, three comparison results Xi, Ai, and Bi by the comparison units 184, 188A, and 188B are accumulated for each input data “i.”

The low accuracy region correct answer rate calculation unit 122 calculates the correct answer rates of the OCR 110, the manual input unit 182, and the recognition mechanisms in the low accuracy region, by using the comparison results Xi, Ai, and Bi accumulated in the accumulation unit 120.

The correct answer rate calculation method by the low accuracy region correct answer rate calculation unit 122 will be described. First, a method of calculating the correct answer rate a of the OCR 112a and the correct answer rate β of the manual input unit 182 will be described.

This calculation method calculates the correct answer rates α and β based on the following three assumptions (a), (b), and (c). (a) When the comparison result X of the comparison unit 184 is “matching,” both the recognition results of the OCR 110 and the manual input unit 182 are correct answers. (b) When the comparison result A of the comparison unit 188A is “matching,” the result of recognition by the OCR 110 is a correct answer. (c) When the comparison result B of the comparison unit 188B is “matching,” the inputting person's input that is received by the manual input unit 182 is a correct answer.

That is, here, the correct answer rates α and β are obtained by regarding that the result of recognition by the OCR is a correct answer in a case of matching the character string input to the manual input unit 182 or 186, and the character string input to the manual input unit 182 is a correct answer in a case of matching the result of recognition by the OCR 110 or the character string input to the manual input unit 186. Based on these assumptions, the low accuracy region correct answer rate calculation unit 122 calculates the correct answer rates a and β according to the following equation (6).

$$\begin{matrix}[ Equation 6 ] & \\ \begin{matrix} α = \frac{1}{N} {\sum }_{i = 1}^{N} ( {X}_{i} \vert {A}_{i} ) \\ β = \frac{1}{N} {\sum }_{i = 1}^{N} ( {X}_{i} \vert {B}_{i} )\end{matrix} \} & ( 6 )\end{matrix}$$

Here, “i” refers to the serial number that is the identification information of the input image data, and “N” refers to the total number of pieces of input data. In addition, “P|Q” refers to an arithmetic operation of which value becomes 1 when P or Q is 1, and becomes 0 when both P and Q are 0.

When the result of comparison by the comparison unit 184 is “matching,” the manual input unit 186 may be caused not to perform the determination. In this case, since the determination result from the manual input unit 186 cannot be obtained, both the comparison results of the comparison units 188A and 188B using the determination result from the manual input unit 186 may be caused to become “0.” In such a case, the low accuracy region correct answer rate calculation unit 122 may calculate the correct answer rates by the following equation (7), instead of the equation (6) above.

$$\begin{matrix}[ Equation 7 ] & \\ \begin{matrix}α = \frac{1}{N} {\sum }_{i = 1}^{N} ( {X}_{i} + {A}_{i} ) \\ β = \frac{1}{N} {\sum }_{i = 1}^{N} ( {X}_{i} + {B}_{i} )\end{matrix} \} & ( 7 )\end{matrix}$$

Next, descriptions will be made on a process of obtaining a correct answer rate y of the recognition mechanisms of the present information processing apparatus for the low accuracy region (i.e., the part including the OCR 110, the manual input unit 182, the comparison unit 184, and the manual input unit 186. Here, it is assumed that the manual input units 182 and 186 have the same feature. That is, the correct answer rates of the manual input units 182 and 186 are regarded as being the same from the statistical viewpoint.

It is assumed that the correct answer rates α and β of the OCR 110 and the manual input unit 182 in the low accuracy region have already been calculated by the method described above. In this example, as described above, it may be regarded that when the number of pieces of input data is sufficiently large, the manual input unit 186 has the same correct answer rate a as that of the manual input unit 182. Accordingly, the low accuracy region correct answer rate calculation unit 122 may calculate the correction rate y by the following equation: γ=αβ+(1−αβ)α.

More specifically, (a) in a case where the recognition result of the OCR 110 is a correct answer, and the input received by the manual input unit 182 is a correct answer, or (b) in a case where both are not correct answers, and the manual input unit 186 is a correct answer, the recognition result or the input is regarded as the correct answer of the entire determination mechanism. The probability of the occurrence of the case (a) is αβ, and the probability of the occurrence of the case (b) is (1−αβ)α which is the product of the probability (1−αβ) other than the case (a) and the probability α that the manual input unit 186 is a correct answer. Thus, the sum of the probabilities of (a) and (b) becomes the final correct answer rate γ.

The high accuracy region correct answer rate estimation unit 124 estimates the correct answer rate of the OCR 110 in the high accuracy region (i.e., where the recognition accuracy is equal to or more than the threshold) by the method shown in the exemplary embodiment or each modification using the correct answer rate α of the OCR 110 calculated by the low accuracy region correct answer rate calculation unit for the low accuracy region. In addition, when the correct answer rate of the entire system is estimated, the correct answer rate of the entire system in the high accuracy region may be estimated from the correct answer rate γ in the low accuracy region by the method shown in the exemplary embodiment or each modification.

The checking processing unit 118 illustrated in FIG. 14 may improve the accuracy of the character recognition result (i.e., the output of the checking processing unit 118) in the low accuracy region, as compared with the method in which one person checks the result of character recognition by the OCR 110 (i.e., the result of recognition by one person is necessarily regarded as a correct answer), and furthermore, may improve the accuracy of the correct answer rate of the OCR 110 in the low accuracy region.

In the example of FIG. 14, a human being checks the result of character recognition by the OCR 110. However, the checking may be performed by a unit other than the human being. As for the unit other than the human being, for example, a character recognition system which is expected to provide a higher correct answer rate of the character recognition than the OCR 110 may be used. This structure may be used for the purpose of reducing the cost by not using the character recognition system in a case where the cost for using character recognition system is high, and thus, a sufficient correct answer rate may be expected from the OCR 110.

In the above-described exemplary embodiments and modifications, a character string in the input image data is recognized. However, the method of the exemplary embodiments and modifications is not limited to the character recognition, and may be applicable to a general information processing apparatus which determines the contents of input data and outputs the determination result. That is, in a system where when the accuracy of a determination by a determining unit (e.g., the OCR 110) for determining the contents of the input data, that is, the extent of possibility that the determination result is a correct answer is equal to or more than a threshold, the determination result from the determining unit is output as it is, and when the accuracy of the determination is less than the threshold, the determination result is checked by another unit, and when the determination result is erroneous, the determination result is corrected, the method of the exemplary embodiments and modifications is applicable to calculating the correct answer rate of the determining unit in the range where the accuracy is equal to or more than the threshold.

The above-described information processing apparatus may be configured by hardware logic circuits, in an example. As another example, the information processing apparatus may be implemented by, for example, causing an equipped computer to execute programs representing the functions of the respective functional modules in the system or apparatus. Here, the computer has a circuit configuration where as hardware, for example, a processor such as a CPU, a memory (primary storage) such as a random access memory (RAM) or a read only memory (ROM), an HDD controller for controlling a hard disk drive (HDD), various input/output (I/O) interfaces, and a network interface for controlling a connection with, for example, a local area network are connected to each other via, for example, a bus. In addition, for example, a disk drive for reading and/or writing with respect to a portable disk recording medium such as a CD or DVD, and a memory reader/writer for reading and/or writing with respect to portable nonvolatile recording media of various standards such as a flash memory may be connected to the bus via, for example, the I/O interfaces. The programs describing the processing contents of the respective functional modules described above are saved in a fixed storage device such as a hard disk drive and installed in a computer, via a recording medium such as a CD or DVD or via a communication unit such as a network. The programs stored in the fixed storage device are read into the RAM and executed by the processor such as the CPU, so that the functional module group described above is implemented. In addition, the information processing apparatus may be configured by a combination of software and hardware.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus useful for a determining system including:
a determining unit that determines an input; a calculation unit that calculates a determination accuracy of the determining unit on the input;
a plurality of post-stage processing units that are each capable of generating an output for the input by performing a post-stage processing on a determination result from the determining unit, have different degrees of dependency on the determination result from the determining unit in generating the output, and are associated with sections, respectively, obtained by dividing, by one or more thresholds, a range where the determination accuracy can lie; and
a control unit that performs a control to cause, to generate the output for the input, one of the plurality of post-stage processing units that corresponds to a section to which the determination accuracy calculated by the calculation unit belongs,
the information processing apparatus being configured to determine the thresholds for the division into the sections for the determination accuracy and comprising:
an acquisition unit that acquires, for each past input for the determining unit, a group of sets each including the determination accuracy on the input and correct/incorrect answer information indicating whether the determination result from the determining unit on the input is a correct or incorrect answer; and
a determination unit that determines each of the thresholds for defining each section by using the group acquired by the acquisition unit in an order starting from a section where the determination accuracy is relatively high and in such a manner that a correct answer rate of the determining unit obtained from the group of sets that belongs a section satisfies a target correct answer rate of the determining unit corresponding to the section.

2. The information processing apparatus according to claim 1, wherein
a target recognition rate of the determining unit corresponding to each section has a higher value as the determination accuracy of the section increases, and
the determination unit determines each of the thresholds for defining each section in an order starting from a section where the target recognition rate is relatively high.

3. The information processing apparatus according to claim 1, wherein
the post-stage processing unit corresponding to the section where the determination accuracy is relatively high uses a lower cost method for generating the output by using the determination result, and
the determination unit determines each of the thresholds for defining each section in an order starting from a section where the cost is relatively low.

4. The information processing apparatus according to claim 1, wherein
the post-stage processing unit corresponding to the section where the determination accuracy is highest directly generates, as the output, the determination result from the determining unit, and
a target correct answer rate set for the determining system is used as the target correct answer rate for the post-stage processing unit corresponding to the section where the determination accuracy is highest.

5. The information processing apparatus according to claim 1, wherein
the plurality of post-stage processing units include a second type of post-stage processing unit that generates an output for the input without using the determination result from the determining unit, and
the second type of post-stage processing unit is associated with a section where the determination accuracy is lowest among the sections.

6. The information processing apparatus according to claim 5, wherein
the target correct answer rate corresponding to the second type of post-stage processing unit is 0.

7. The information processing apparatus according to claim 1, wherein
the plurality of post-stage processing units includes a first post-stage processing unit that directly generates, as the output, the determination result from the determining unit, a second post-stage processing unit that generates the output based on a determination result obtained by a human operator on the input without using the determination result from the determining unit, and a third post-stage processing unit that generates the output through a comparison between the determination result from the determining unit and the determination result obtained by a human operator on the input, and
a target correct answer rate set for the determining system is used as the target correct answer rate for the first post-stage processing unit,
0 is used as the target correct answer rate for the second post-stage processing unit, and
the target correct answer rate for the third post-stage processing unit is obtained from the correct answer rate of the human operator and the correct answer rate of the determining unit.

8. The information processing apparatus according to claim 1, wherein
the acquisition unit acquires, instead of the set of the determination accuracy and the correct/incorrect answer information, a set of the determination accuracy and information on a result of accumulation of the correct/incorrect answer information for each determination accuracy within a range from the determination accuracy to a largest value of determination accuracy, and
the determination unit uses the information on the result of accumulation for each determination accuracy to obtain the correct answer rate of a section for which the threshold is to be determined.

9. An information processing apparatus comprising:
a determining unit that determines an input;
a calculation unit that calculates a determination accuracy of the determining unit on the input;
a plurality of post-stage processing units that are each capable of generating an output for the input by performing a post-stage processing on a determination result from the determining unit, have different degrees of dependency on the determination result from the determining unit in generating the output, and are associated with sections, respectively, obtained by dividing, by one or more thresholds, a range where the determination accuracy can lie;
a control unit that performs a control to cause, to generate the output for the input, one of the plurality of post-stage processing units that corresponds to a section to which the determination accuracy calculated by the calculation unit belongs;
an acquisition unit that acquires, for each past input for the determining unit, a group of sets each including the determination accuracy on the input and correct/incorrect answer information indicating whether the determination result from the determining unit on the input is a correct or incorrect answer; and
a determination unit that determines each of the thresholds for defining each section by using the group acquired by the acquisition unit in an order starting from a section where the determination accuracy is relatively high and in such a manner that a correct answer rate of the determining unit obtained from the group of sets that belongs a section satisfies a target correct answer rate of the determining unit corresponding to the section.

10. An information processing apparatus comprising:
a determining unit that determines an input to obtain a determination result;
a checking unit that checks whether the determination result is a correct or incorrect answer, adopts the determination result when the determination result is a correct answer, and obtains an accurate determination result on the input and adopts the obtained determination result when the determination result is an incorrect answer;
a unit that obtains a degree indicating a possibility that the determination unit provides a correct answer for each input;
an output control unit that performs a control to output the determination result from the determining unit without using the checking unit with respect to the input for which the degree is equal to or more than a threshold and to output the determination result adopted by the checking unit when the degree is less than the threshold;
a correct answer rate calculation unit that calculates, as a correct answer rate of the determining unit in a first range where the degree is less than the threshold, a proportion of an input determined as a correct answer by the checking unit among inputs within the first range; and
an estimation unit that estimates, based on the correct answer rate in the first range, a correct answer rate of the determining unit in a second range where the degree is equal to or more than the threshold.

11. The information processing apparatus according to claim 10, wherein
the first range is from a value that is determined to be more than 0 according to a predetermined criterion to the threshold.

12. The information processing apparatus according to claim 10, wherein
the estimation unit assumes that the correct answer rate calculated by the correct answer rate calculation unit corresponds to a first representative value of the degree in the first range, and estimates a correct answer rate corresponding to a second representative value of the degree in the second range by a linear interpolation between the correct answer rate corresponding to the first representative value and a predetermined maximum correct answer rate at a maximum value that the degree can reach.

13. The information processing apparatus according to claim 10, wherein
the correct answer rate calculation unit obtains each correct answer rate for a plurality of ranges where the degree is less than the threshold, and
the estimation unit estimates the correct answer rate in the second range based on a tendency of a change in the correct answer rate according to the degree for each of the plurality of ranges.

14. The information processing apparatus according to claim 10, wherein
the correct answer rate calculation unit obtains each correct answer rate for a plurality of ranges where the degree is less than the threshold, and
the estimation unit estimates a function for obtaining the correct answer rate corresponding to the degree from a relationship between the correct answer rate for each of the plurality of ranges and the degree, and estimates the correct answer rate in the second range by using the estimated function.

15. The information processing apparatus according to claim 10, wherein
the estimation unit obtains a probability density function of the degree from a distribution of occurrence frequency of the degree, and estimates the correct answer rate in the second range by using the probability density function.
